(19) United States
(12) Patent Application Publication
(10) Pub. No.: US 2003/0177268 A1
(43) Pub. Date: Sep. 18, 2003

(54) Home appliance networking system having private internet protocol address (or port numbers) and method for controlling the same

(75) Inventors: Sang Chul Youn, Kyungki-do (KR); Duck Goo Jeon, Seoul-si (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/378,819

(22) Filed: Mar. 5, 2003

(30) Foreign Application Priority Data
Mar. 15, 2002 (KR) 2002-14160

(51) Int. Cl. G06F 15/16

(52) U.S. Cl. 709/245

(57) ABSTRACT

A home appliance networking system and a method for controlling the same. An IP sharing unit assigns private IP addresses or port numbers respectively to a plurality of home appliances in a home networking system and is assigned a public IP address so that the home networking system can be accessed from an external network. A plurality of communication processors are connected respectively to product controllers of the home appliances to store corresponding ones of the private IP addresses or port numbers assigned by the IP sharing unit and enable corresponding ones of the home appliances to transmit and receive data to/from an internal network of the home networking system through the corresponding private IP addresses or port numbers. Therefore, the home appliance networking system can be constructed in a simpler manner and at a lower cost to operate the home networking system efficiently.

### BACKGROUND OF THE INVENTION

1. Field of the Invention

The present invention relates to home appliance networking systems and methods for controlling the same. In particular, the present invention relates to a home appliance networking system and a method for controlling the same, wherein private Internet Protocol (IP) addresses or port numbers are assigned respectively to a plurality of home appliances in a home networking system so that the home appliances can transmit and receive data to/from a network through the assigned private IP addresses or port numbers. The present invention makes it possible to construct a home networking system in a simpler manner and to curtail costs required for the system construction.

2. Description of the Related Art

A home appliance networking system has recently been highlighted in which a plurality of home appliances are interconnected via an internal network of a home and the internal network is connected to an external Internet network, thereby enabling a user to control the home appliances from anywhere inside and outside of the home.

In such a home appliance networking system, particularly, the user can not only recognize state (e.g., status or condition) information of a specific home appliance anywhere inside the home, but also control the specific home appliance through the use of a controller e.g., such as a computer, from any place outside of the home. In this regard, the home appliance networking system has obtained favorable responses from many consumers, and thus is becoming has become more widespread in its application day by day.

However, the above-mentioned home appliance networking system has a disadvantage in that a local area network (LAN) must be constructed in the home or building to interconnect the home appliances via the internal network of the home and control the interconnected appliances in an integrated manner, resulting in a great cost being incurred.

Moreover, in order to connect the home appliances to the internal network of the home and transmit and receive control and state information between the home appliances and the internal network, a high-price LAN card and a communication processable central processing unit (CPU) of the personal computer (PC) class must be installed in each of the home appliances.

However, it is the current reality that the installation of the LAN cards and PC-class CPUs in the respective home appliances raises manufacturing costs of the respective appliances, thus reducing their market competitiveness. Furthermore, new production lines are required to install PC-class CPUs and LAN cards of new models in the home appliances. As a result, costs required for construction of the new production lines raise the prices of the home appliances still more.

Furthermore, the installation of the LAN cards and PC-class CPUs in the respective home appliances increases the costs of certain ones of the appliances not requiring control through the internal network, and in turn results in wasting of resources.

### SUMMARY OF THE INVENTION

Therefore, the present invention has been made in view of the above problems, and it is an object of the present invention to provide a home appliance networking system and a method for controlling the same, wherein an IP sharing unit is provided to assign private IP addresses or port numbers respectively to a plurality of home appliances in a home networking system, and a plurality of communication processors are provided to enable corresponding ones of the home appliances to transmit and receive data to/from a network through the private IP addresses or port numbers assigned by the IP sharing unit, thereby making it possible to operate the home networking system more simply and efficiently.

In accordance with one aspect of the present invention, the above and other objects can be accomplished by the provision of a home appliance networking system including a networking device that connects an internal network of a home networking system to an external network of the home appliance networking system and an Internet Protocol (IP) sharing device to which a public IP address is assigned to enable a user to access the home appliance networking system from the external network. A plurality of communication processors are connected respectively to each of a plurality of appliance or product controllers, the communication processors enabling data communication between one of the home appliances and the internal network by obtaining IP addresses or private addresses from the IP sharing device.

In accordance with another aspect of the present invention, a method is provided for controlling a home appliance networking system, comprising assigning a public IP address to an IP sharing device, the IP sharing device assigning private IP addresses or port numbers respectively to a plurality of home appliances connected to an internal network of a home networking system. A computing device is connected to the IP sharing device to allow the computing device to input a control command to a specific one of the plurality of home appliances connected to the internal network. The IP sharing device is additionally connected to the plurality of home appliances connected to the internal network as the computing device is connected to the IP sharing device by the connecting. A control command is input through the computing device to a plurality of the home appliances with the private IP addresses or the port numbers assigned by the IP sharing device connected by the further connecting by corresponding one of the home appliances is controlled in response to the control command input by the computing.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the construction of a preferred embodiment of a home appliance networking system in accordance with the present invention;

FIG. 2 is a block diagram showing the construction of an alternative embodiment of the home appliance networking system in accordance with the present invention;

FIG. 3 is a block diagram of a first-type communication processor in the home appliance networking system in accordance with the present invention;

FIG. 4 is a block diagram of a second-type communication processor in the home appliance networking system in accordance with the present invention; and

FIG. 5 is a flow chart illustrating a method for controlling the home appliance networking system in accordance with the present invention.

### DESCRIPTION OF THE PREFERRED EMBODIMENTS

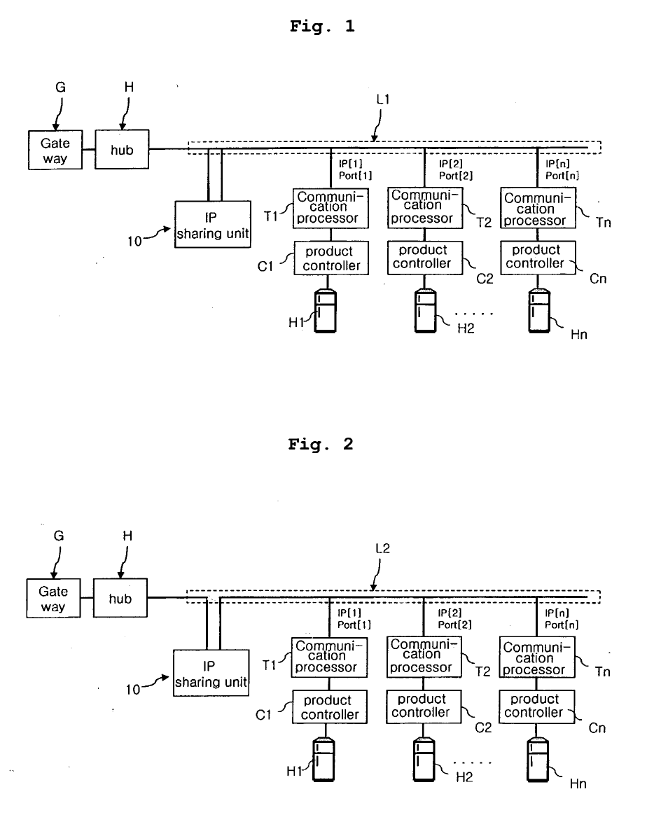

With reference to FIG. 1, there is shown in block form the construction of a preferred embodiment of a home appliance networking system in accordance with the present invention. As shown in this drawing, the home appliance networking system comprises an existing LAN L1, which is an internal network of a home networking system constructed in a home or building, and networking equipment for connecting the internal network of the home networking system to an external network of the home networking system. An IP sharing unit 10 is assigned a public IP address for enabling a user to gain access to the internal network from the external network through the networking equipment. A plurality of communication processors T1-Tn are connected respectively to appliance (or product) controllers C1-Cn of a plurality of home appliances (or products) H1-Hn for enabling corresponding ones of the home appliances to be assigned private IP addresses from the IP sharing unit 10 and transmit and receive data to/from the internal network using the assigned private IP addresses, respectively.

The IP sharing unit 10 preferably sets and assigns unique private IP addresses respectively to the plurality of home appliances H1-Hn. Alternatively, the IP sharing unit 10 may assign the same private IP addresses with different port numbers respectively to the plurality of home appliances H1-Hn. Further, the IP sharing unit 10 preferably maps the private IP addresses or port numbers assigned respectively to the plurality of home appliances H1-Hn, to the home appliances H1-Hn and stores the resulting map information. As a result, a control command from the external network is transmitted to a private IP address or port number of a corresponding home appliance on the basis of the map information stored in the IP sharing unit 10.

The private IP addresses or port numbers assigned respectively to the home appliances by the IP sharing unit 10 are stored respectively in the plurality of communication processors T1-Tn connected respectively to the appliance controllers of the home appliances. After storing the private IP addresses or port numbers assigned by the IP sharing unit 10, the communication processors T1-Tn send only data associated with the home appliances corresponding to the stored private IP addresses or port numbers to the product controllers C1-Cn, respectively. Thus, the plurality of home appliances H1-Hn are controllable according to only the associated data.

The networking equipment includes a gateway G acting as an ingress of the internal network of the home networking system, and a hub H for receiving data from the external network via the gateway G, sending the received data to the IP sharing unit 10, receiving data from the IP sharing unit 10 and sending the received data to the external network via the gateway G.

As shown in FIG. 1, the IP sharing unit 10 and the plurality of home appliances H1-Hn are connected to the existing LAN in such a manner that an internal data line to the internal network and an external data line to the external network are physically interconnected via the IP sharing unit 10. As a result, data transmitted and received via the IP sharing unit 10 must be passed through the IP sharing unit 10 as shown in FIG. 1.

Alternatively, the IP sharing unit 10 may transmit and receive data over an internal network, which is a newly constructed LAN L2 as shown in FIG. 2, not the existing LAN L1. In this case, the internal data line to the internal network and the external data line to the external network are separated from each other on the IP sharing unit 10 as shown in FIG. 2.

In a similar manner to that in the home appliance networking system shown in FIG. 1, in the home appliance networking system of the present invention shown in FIG. 2, the IP sharing unit 10 has a public IP address assigned thereto, and sets and assigns private IP addresses or port numbers to the plurality of home appliances H1-Hn.

Accordingly, the user can access the IP sharing unit 10 from the external network using the public IP address of the IP sharing unit 10. The IP sharing unit 10 is further adapted to assign the private IP addresses or port numbers to the plurality of home appliances H1-Hn and control the flow of data to the assigned private IP addresses or port numbers. Therefore, the home networking system is controllable through the IP sharing unit 10.

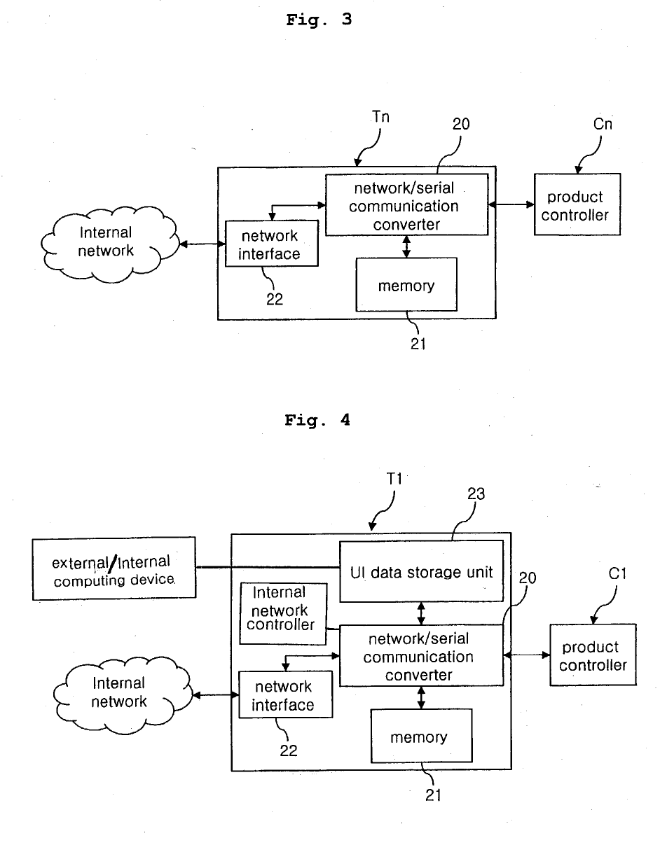

FIG. 3 shows an internal structure of a first-type of communication processor in the home appliance networking system in accordance with the present invention, namely, the communication processor Tn connected to the appliance controller Cn of the nth one In of the plurality of home appliances H1-Hn. The communication processors continuously exchange data with the appliance or product controllers to determine e.g. whether the appliances are operating properly.

As shown in FIG. 3, the first-type communication processor Tn according to the present invention includes a network/serial communication converter 20 for converting the format of data appropriately to standards of the internal network and appliance controller Cn such that the corresponding home appliance Hn transmits and receives the data to/from the internal network. A memory 21 is provided for storing the private IP address or port number assigned to the corresponding home appliance Hn by the IP sharing unit 10. The memory 21 is preferably a read only memory (ROM).

The first-type communication processor Tn further includes a network interface 22 for transferring data, outputted from the appliance controller Cn and then format-converted appropriately to the standard of the internal network by the network/serial communication converter 20, to the internal network, and transferring data associated with the corresponding home appliance Hn from the internal network to the network/serial communication converter 20.

The network/serial communication converter 20 preferably transmits and receives data to/from the appliance controller Cn in a UART standard-based serial communication manner. The network/serial communication converter 20 transmits and receives data to/from the network interface 22 in a network communication manner to transmit and receive the data to/from the internal network.

As an alternative, data format-converted appropriately to the standard of the internal network by the network/serial communication converter 20 may be transferred directly to the internal network, not via the network interface 22, and data from the internal network may also be transferred directly to the network/serial communication converter 20, not via the network interface 22. That is, the function of the network interface 22 may be included in the network/serial communication converter 20.

FIG. 4 shows an internal structure of a second-type of communication processor in the home appliance networking system in accordance with the present invention. In particular, the communication processor T1 is connected to the appliance controller C1 of a specific one, for example, H1 of the plurality of home appliances H1-Hn. As shown in FIG. 4, in a different manner from that of FIG. 3, the second-type communication processor T1 further includes, in addition to the network/serial communication converter 20, memory 21 and network interface 22, a user interface (UI) data storage unit 23 for storing UI data for execution of a UI program appropriate to the control of the plurality of home appliances HI-Hn connected to the internal network. The UI data stored in the UI data storage unit 23 is preferably sent to an external computing device which accesses the IP sharing unit 10 over the external network to send control commands to the plurality of home appliances of the home networking system, or to an internal computing device which sends control commands to the plurality of home appliances over the internal network.

The external or internal computing device executes the UI program in response to the UI data sent thereto, so the user can input desired control commands to the plurality of home appliances through the executed UI program using the external or internal computing device. The inputted control commands are sent to home appliances with corresponding private IP addresses or port numbers via the IP sharing unit 10.

The second-type communication processor T1 further includes an internal network controller for managing transmission and reception of data over the internal network by the plurality of home appliances. Namely, the second-type communication processor T1 may also function as a network management system for managing transmission and reception of data by the home networking system.

In brief, the home appliance networking system of one home networking system can comprise the second-type communication processor T1 connected to one IP sharing unit 10 and the appliance controller C1 of one home appliance H1, and the first-type communication processors T2-Tn connected respectively to the appliance controllers C2-Cn of the other home appliances H2-Hn. Therefore, the UI data storage unit is contained in only one communication processor of the home appliance networking system, which acts as the network management system for performing the function of the internal network controller. Consequently, the home appliance networking system can be efficiently operated with no need to provide the UI data storage unit in a plurality of communication processors or allow them to perform the function of the internal network controller.

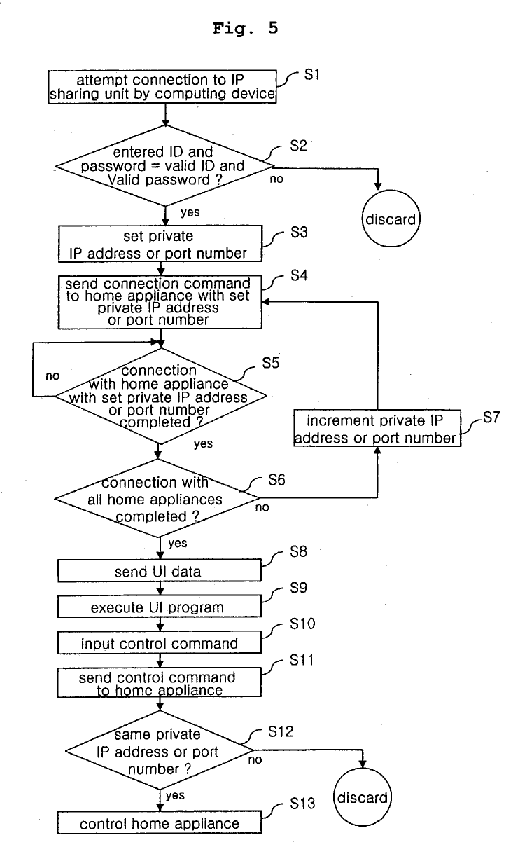

FIG. 5 is a flow chart illustrating a method for controlling the home appliance networking system in accordance with the present invention.

As shown in FIG. 5, at the first step S1, a computing device attempts a connection to an IP sharing unit assigned a public IP address. At this time, the computing device sends an identification (ID) and password entered by a user to the IP sharing unit while attempting the connection thereto.

At the second step S2, the IP sharing unit determines whether the ID and password sent from the computing device are the same as a valid ID and valid password stored therein.

If the ID and password sent from the computing device are determined to be the same as the valid ID and valid password at the second step S2, the IP sharing unit sets a private IP address or port number of a home appliance to be connected, from among a plurality of home appliances connected to an internal network at the third step S3. Note that the IP sharing unit has previously assigned private IP addresses or port numbers respectively to the plurality of home appliances.

At the fourth step S4, the IP sharing unit sends a connection command to the home appliance with the private IP address or port number set at the third step S3.

At the fifth step S5, the IP sharing unit determines whether its connection with the home appliance to which the connection command has been sent at the fourth step S4 has been completed.

Upon determining at the fifth step S5 that the home appliance connection has been completed, the IP sharing unit determines at the sixth step S6 whether its connection with all the home appliances connected to the internal network has been completed. At this time, because the IP sharing unit stores information regarding the private IP addresses or port numbers of all the home appliances connected to the internal network, it can determine on the basis of the stored information whether its connection with all the home appliances has been completed. On the other hand, if it is determined at the fifth step S5 that the home appliance connection has not been completed, the IP sharing unit returns to the fifth step S5 to again determine whether the home appliance connection has been completed.

In the case where it is determined at the sixth step S6 that the connection with all the home appliances has not been completed, the IP sharing unit increments the private IP address or port number set at the third step S3 by one at the seventh step S7 and then returns to the fourth step S4.

However, if it is determined at the sixth step S6 that the connection with all the home appliances has been completed, a second-type communication processor sends, at the eighth step S8, UI data to the computing device that has attempted the connection to the IP sharing unit at the first step S1.

At the ninth step S9, the computing device executes a UI program in response to the UI data sent thereto.

At the tenth step S10, the user inputs a control command through the UI program executed by the computing device.

At the eleventh step S11, the computing device sends the control command inputted through the UI program to the IP sharing unit, which then transfers the sent control command to a private IP address or port number of a corresponding home appliance.

At the twelfth step S12, a communication processor of the corresponding home appliance determines whether a private IP address or port number of the control command transferred at the eleventh step S11 is the same as the private IP address or port number of the corresponding home appliance.

If the private IP address or port number of the transferred control command is determined to be the same as the private IP address or port number of the corresponding home appliance at the twelfth step S12, the communication processor of the corresponding home appliance sends the transferred control command to the corresponding home appliance, which is then controlled according to that control command.

On the other hand, in the case where it is determined at the twelfth step S12 that the private IP address or port number of the transferred control command is not the same as the private IP address or port number of the corresponding home appliance, the communication processor of the corresponding home appliance discards the transferred control command.

As apparent from the above description the present invention provides a home appliance networking system and a method for controlling the same, wherein an IP sharing unit assigns private IP addresses or port numbers respectively to a plurality of home appliances in a home networking system and is assigned a public IP address so that the home networking system can be accessed from an external network, and a plurality of communication processors are connected respectively to appliance controllers of the home appliances to store corresponding ones of the private IP addresses or port numbers assigned by the IP sharing unit and enable corresponding ones of the home appliances to transmit and receive data to/from an internal network of the home networking system through the corresponding private IP addresses or port numbers. Therefore, the home appliance networking system can be constructed in a simpler manner and at a lower cost to operate the home networking system efficiently.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The present disclosure relates to subject matter contained in priority Korean Application No. 2002-0014160, filed on Mar. 15, 2002, which is herein expressly incorporated by reference in its entirety.

What is claimed is:

1. A home appliance networking system comprising:
networking device that connects an internal network of a home networking system to an external network of said home appliance networking system;
an Internet Protocol (IP) sharing device to which a public IP address is assigned to enable for a user to access to said home appliance networking system from said external network; and
a plurality of communication processors connected respectively to each of a plurality of appliance controllers, said communication processors enabling data communication between said home appliances and said internal network by obtaining one of IP addresses and port numbers from said IP sharing device.

2. The home appliance networking system as set forth in claim 1, wherein said networking device comprises:
a gateway acting as an ingress of said internal network; and
a hub that transmits and receives data between said gateway and said IP sharing device.

3. The home appliance networking system as set forth in claim 1, wherein said communication processors are configured to continuously exchange data with said appliance controllers to determine whether said corresponding home appliances are normally operated.

4. The home appliance networking system as set forth in claim 1, wherein each of said communication processors comprises: a network/serial communication converter that converts a format of data from said product controller to standards of said internal network and said product controller of said corresponding home appliance such that said corresponding home appliance transmits and receives the data to/from said internal network; and
a memory that stores one of said private IP address and said port number assigned to said corresponding home appliance by said IP sharing device.

5. The home appliance networking system as set forth in claim 4, wherein said memory is a read only memory.

6. The home appliance networking system as set forth in claim 4, wherein each of said communication processors further comprises a network interface that transfers data output from said appliance controller of said corresponding home appliance and then format-converted to said standard of said internal network by said network/serial communication converter to said internal network, and transfers data associated with said corresponding home appliance from said internal network to said network/serial communication converter.

7. The home appliance networking system as set forth in claim 6, wherein each of said communication processors further comprises an internal network controller that manages transmission and reception of data over said internal network by said plurality of home appliances.

8. The home appliance networking system as set forth in claim 6, wherein each of said communication processors further comprises a user interface (UI) data storage unit that stores UI data for execution of a UI program appropriate to the control of said plurality of home appliances connected to said internal network.

9. The home appliance networking system as set forth in claim 8, wherein said UI data storage unit is configured to send the stored UI data to an external computing device, said external computing device accessing said IP sharing device over said external network to control said home appliances connected to said internal network, and executing said UI program in response to said UI data sent thereto so that control commands can be input through said external computing device.

10. The home appliance networking system as set forth in claim 8, wherein said UI data storage unit is configured to send the stored UI data to an internal computing device, said internal computing device being connected to said internal network to send control commands to said plurality of home appliances, and executing said UI program in response to said UI data sent thereto so that said control commands can be input through said internal computing device.

11. A method for controlling a home appliance networking system, comprising:
assigning a public IP address to an IP sharing device, the IP sharing device assigning private IP addresses or port numbers respectively to a plurality of home appliances connected to an internal network of a home networking system;
connecting a computing device to the IP sharing device to allow the computing device to input a control command to a specific one of the plurality of home appliances connected to the internal network;
second-connecting the IP sharing device to a plurality of the home appliances connected to the internal network as the computing device is connected to the IP sharing device by the connecting;
inputting the control command through the computing device to the plurality of home appliances with the private IP addresses or the port numbers assigned by the IP sharing device connected at the second-connecting; and
controlling a corresponding one of the home appliances in response to the input control command.

12. The method as set forth in claim 11, further comprising:
allowing the IP sharing device to assign the private IP addresses or the port numbers respectively to the plurality of home appliances before the connecting is performed.

13. The method as set forth in claim 11, wherein the connecting comprises:
allowing the computing device to access the IP sharing device using the public IP address assigned thereto;
determining whether an identification (ID) and password entered through the computing device while accessing the IP sharing device are valid; and
third-connecting the computing device to the IP sharing device if it is determined by the determining that the entered ID and password are valid.

14. The method as set forth in claim 11, wherein the second-connecting comprises:
allowing the IP sharing device to set a private IP address or port number of a home appliance to be connected, among the private IP addresses or port numbers assigned to the plurality of home appliances;
fourth connecting the IP sharing device to the home appliance with the private IP address or port number set at the allowing; and
determining whether the IP sharing device has been connected to all the plurality of home appliances connected to the internal network and, if the IP sharing device has not been connected to all the plurality of home appliances connected to the internal network, incrementing the set private IP address or port number by one and then returning to the fourth-connecting.

15. The method as set forth in claim 11, further comprising, after the connecting and before the inputting,:
storing UI data for execution of a UI program in a communication processor and sending the stored UI data to the connected computing device, the UI program being executed to input the control command to the plurality of home appliances, the communication processor transmitting and receiving data between the internal network and the home appliances; and
allowing the computing device to execute the UI program in response to the UI data sent thereto.
